(19) United States
(12) Patent Application Publication
(10) Pub. No.: US 2018/0238170 A1
(43) Pub. Date: Aug. 23, 2018

(54) ASYMMETRIC PICK TOOL WITH AN ASPECT RATIO BETWEEN LEADING AND TRAILING EDGES

(71) Applicants: ELEMENT SIX GMBH, BURGHAUN (DE); ELEMENT SIX (UK) LIMITED, DIDCOT, OXFORDSHIRE (GB)

(72) Inventors: MARKUS KILIAN SCHARTING, BURGHAUN (DE); BERND HEINRICH RIES, BURGHAUN (DE); CHARLES SIMON JAMES PICKLES, DIDCOT (GB); SERENA BONETTI, DIDCOT (GB); PETER ROBERT BUSH, DIDCOT (GB); JAMES FOLKERT, CENTRALIA, IL (US); JOHN HALLBERG, MERCER, PA (US); JOHN RALPH FREDERICK, ALLISON PARK, PA (US); BULENT TIRYAKI, FRANKLIN, PA (US); JAMES KRELLNER, FRANKLIN, PA (US); RANDY ARNOLD, HARRISVILLE, PA (US); DAVID MEADE, FRANKLIN, PA (US)

(21) Appl. No.: 15/753,558

(22) PCT Filed: Aug. 19, 2016
(86) PCT No.: PCT/EP2016/069684

§ 371 Date: Feb. 20, 2018

Related U.S. Application Data
(60) Provisional application No. 62/209,009, filed on Aug. 24, 2015.

(30) Foreign Application Priority Data
Oct. 1, 2015 (GB) 1517360.2

(51) Int. Cl. E21C 35/183; E21B 10/46; B28D 1/18

(52) U.S. Cl. CPC E21C 35/183; E21C 2035/1813; B28D 1/186; E21B 10/46

(57) ABSTRACT

A pick tool comprising a strike tip and a pick tool body, the pick tool body including a non-rotating strike tip at a first end of the pick tool body. A shaft is provided at a second end of the pick tool body, the shaft being configured to pass through an opening in a surface of a pick tool holder, the shaft being configured in use to be non-rotationally attached to the pick tool holder. The shaft projects from a pick tool abutment surface such that, when the pick tool is attached to the pick tool holder, the abutment surface abuts the pick tool holder surface. The abutment surface has an aspect ratio between its length and width of between 1.5:1 and 3:1. The pick tool body comprises a leading edge and a trailing edge, the leading edge being, in use, the edge that first contacts a formation, the trailing edge having an angle of less than 18° between a main axis of the pick tool and an axis from the strike tip to the abutment surface at the trailing edge.

### FIELD OF THE INVENTION

The field of the invention is pick tools and pick tool bodies.

### BACKGROUND

Conventional continuous mining machines include a rotating drum that has a plurality of pick tools attached to it. Each pick tool is attached to a pick tool holder (sometimes referred to as a bit block or holder block), and each pick tool holder is attached to the rotating drum. When the drum is rotated, a striking surface on each pick tool is brought into contact with a formation (such as a rock formation). This action mechanically breaks down and degrades the formation.

A known pick tool body 100 is illustrated in FIG. 1. The pick tool body is typically made from a grade of steel. The pick tool body 100 has a first end 101 to which a striking surface is attached. The striking surface may be made from any suitable hard material, such as tungsten carbide based cermets, polycrystalline diamond (PCD) or polycrystalline cubic boron nitride (PCBN), or suitable blend of hard materials. A main body 102 extends from the striking surface and increases in radius. A shoulder 103 is the point of the maximum radius of the pick tool body 100. A shaft 104 extends below the shoulder 103. The shaft 104 is used to attach the pick tool body 100 to a pick tool holder. A lower surface of the shoulder abuts an upper surface of the pick tool holder. The larger radius at the shoulder 103 provides a better transfer of loads from the pick tool body 100 to the pick tool holder when the striking surface impacts a formation.

### SUMMARY

A problem with existing pick tool holders is that the wide radius at the shoulder 103 means that, as the pick tool 100 impacts a formation and passes through the formation, a large amount of the main body 102 may be in contact with the formation. This leads to a loss of energy, excessive wear on the pick tool body 100 and, in some circumstances, the contact between the steel body and the formation can lead to sparking.

It is an object to provide an improved pick tool that mitigates some of these problems.

Viewed from a first aspect there is provided a pick tool comprising a strike tip and a pick tool body. The pick tool body comprises a non-rotating strike tip at a first end of the pick tool body. A shaft is provided at a second end of the pick tool body, the shaft being configured to pass through an opening in a surface of a pick tool holder, the shaft being configured in use to be non-rotationally attached to the pick tool holder. The shaft projects from a pick tool abutment surface such that, when the pick tool is attached to the pick tool holder, the abutment surface abuts the pick tool holder surface. The abutment surface has an aspect ratio between its length and width of between 1.5:1 and 3:1. The pick tool body comprises a leading edge and a trailing edge, the leading edge being, in use, the edge that first contacts a formation, the trailing edge having an angle of less than 18° between a main axis of the pick tool and an axis from the strike tip to the abutment surface at the trailing edge. An advantage of this is that the abutment surface is sufficiently large to distribute forces between the pick tool body and the pick tool holder, but the pick tool body is relatively narrow and so minimizes drag and friction as it passes through a formation being degraded by the pick tool. Furthermore, the risk of the trailing edge contacting the formation being degraded is minimized by the angle of the trailing edge, reducing the risk of heating and abrading the pick tool body and reducing the risk of spark formation.

As an option, the strike tip comprises a working surface, the working surface comprising a superhard material having a Vickers hardness of at least 25 GPa. As a further option, the superhard material comprises any of polycrystalline diamond, PCD, polycrystalline cubic boron nitride, PCBN, a composite of tungsten carbide and any of diamond and cubic boron nitride, leached PCD, inter-grown cubic boron nitride and thermally stable polycrystalline (TSP) diamond composite.

As an option, the pick tool body further comprises a surface formation arranged to interlock with a corresponding surface formation on the pick tool holder to prevent relative rotation between the pick tool holder and the pick tool. An example of such a surface formation is a flat surface on or close to a portion of the shaft. However, the skilled person will appreciate that other anti-rotation mechanism may be applied. For example, the shaft could have a non-circular cross-section shape to interlock with a corresponding shaped opening in the pick tool holder.

As an option, the strike tip is attached to a cemented carbide holder, the cemented carbide holder comprising a projection, wherein the projection is non-rotationally fitted into an opening at the first end of the pick tool body.

The pick tool is optionally usable for any of mining, road milling, or drilling into the earth.

According to a second aspect, there is provided a pick tool body. The pick tool body has an attachment point at a first end of the pick tool body configured to affix to a non-rotating strike tip. A shaft is provided at a second end of the pick tool body, the shaft being configured to pass through an opening in a surface of a pick tool holder. The shaft projects from a pick tool abutment surface such that, when the pick tool is attached to the pick tool holder, the abutment surface abuts the pick tool holder surface. The abutment surface has an aspect ratio between its longest dimension and its second longest dimension of between 1.5:1 and 3:1. The pick tool body comprises a leading edge and a trailing edge, the leading edge being, in use, the edge that first contacts a formation, the trailing edge having an angle of less than 18° between a main axis of the pick tool and an axis from the strike tip to the abutment surface at the trailing edge.

As an option, the pick tool body further comprises a surface formation arranged to interlock with a corresponding surface formation on the pick tool holder to prevent relative rotation between the pick tool holder and the pick tool body. As a further option, the surface formation comprises a flat surface on or close to a portion of the shaft.

The pick tool body optionally comprises an opening arranged to receive a projection from a cemented carbide strike tip holder for securing the strike tip holder to the pick tool body.

The pick tool body is optionally usable for any of mining, road milling, or drilling into the earth.

### BRIEF DESCRIPTION OF THE DRAWINGS

Non-limiting example arrangements to illustrate the present disclosure are described hereafter with reference to the accompanying drawings, of which:

FIG. 1 is a perspective view of a known pick tool;

FIGS. 2a and 2b are schematic side elevation cross-section views of the pick tool from two different angles;

FIG. 3 is a schematic side elevation view of a pick tool attached to a pick tool holder;

FIG. 4 is a top down view of a pick tool attached to a pick tool holder;

FIG. 5 is a perspective view of a pick tool attached to a pick tool holder, with the pick tool holder shown in a cutaway view;

FIG. 6 is a schematic cross-section view of an exemplary pick tool shaft at the shoulder; and

FIG. 7 is a schematic cross-section side elevation view of a pick tool showing leading and trailing edges.

### DETAILED DESCRIPTION

Many strike tips for mining and road milling operations are formed from tungsten carbide based cermets (hereafter referred to as “tungsten carbide”). The tungsten carbide experiences significant wear during its life, and so some strike tips are designed to rotate to ensure that the wear on the strike tip is evenly distributed about the strike tip. In recent years, superhard materials such as polycrystalline diamond (PCD) and polycrystalline cubic boron nitride (PCBN) have been provided at the working surface of the strike tip. The wear on superhard materials is much lower than the wear on tungsten carbide, and so it is other parts of the pick tool (such as the rotation mechanism) that fail before the strike tip fails. For this reason, it is thought that a strike tip that comprises a superhard material should not rotate. The hardness of the superhard materials makes pick rotation unnecessary to obtain uniform wear. Furthermore, superhard materials are brittle. Rock cutting processes typically result in sawtooth shape force-time relation which includes a certain degree of pick impact on fresh rock surface. Another source causing picks to impact on fresh rock surface is the cutting vibrations due to the fluctuations in the reaction forces acting on cutter head carrying arm. If a pick with a superhard tip is made free to rotate, then this could cause additional impacts on the superhard tip during cutting due to the gap between the pick shank and the sleeve/holder. These additional impacts caused by rotation mechanisms should be avoided.

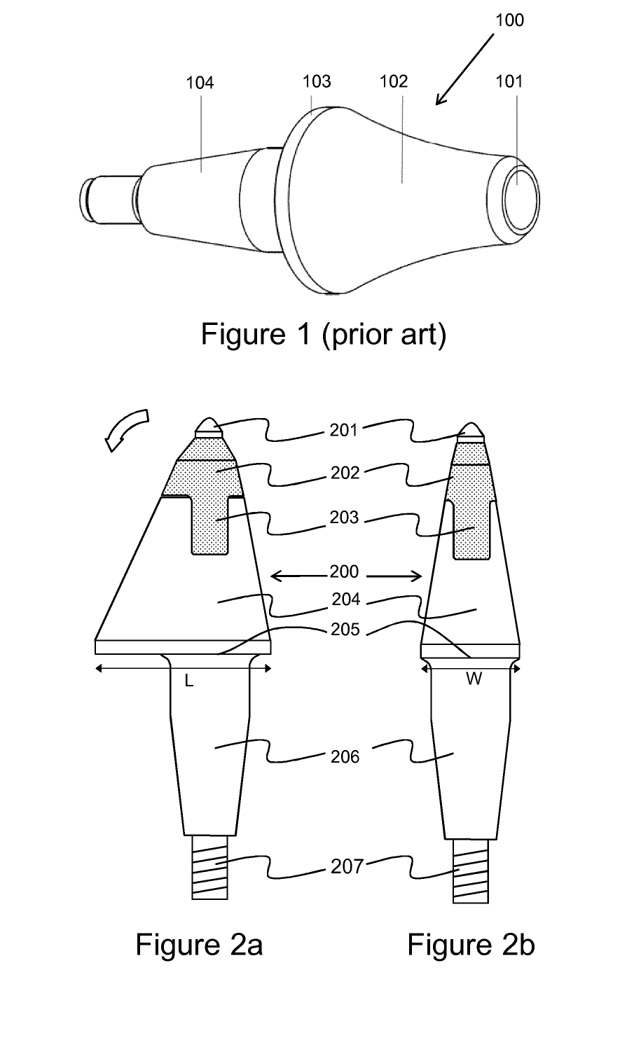

As shown in FIG. 1, a known pick body 100 has a large circular surface area at the shoulder 103 in order to improve load distribution between the pick tool body 100 and the pick tool holder. However, this has a disadvantage in that the main body 102 of the pick tool body 100 is circular and so has a maximum width as it passes through a rock or road formation of the diameter of the circle at the shoulder 103. This width is not just a problem at the shoulder but all along the height of the main body 102 from the shoulder 103 to the first end 101. The pick tool body 100 therefore undergoes excessive wear owing to this width. It also causes drag as it passes through a formation (which in turn requires additional energy) and can cause sparking, which is to be avoided in a mining environment where flammable gases may be present. Drag and sparking arise from inefficient contact in a certain region on the pick body, which should be avoided for better cutting efficiency and a safer cutting environment. Furthermore, the flow of spoil around the pick tool body 100 causes wear, and a more efficient pick tool body shape leads to less resistance to spoil flow.

One way to address this problem is to reduce the surface area of the pick tool body 100 at the shoulder 103. However, this would increase the force per unit area transmitted from the shoulder 103 to the pick tool holder with each impact, increasing the risk of damage to the pick tool body 100 and to the pick tool holder, and potentially reducing the life of the pick tool body 100 and/or the pick tool holder.

The inventors have realized that changing the shape of a pick tool body can reduce the drag of the pick tool as it passes through a rock formation, reducing required energy, damage to the pick tool and the risk of sparking, while maintaining the surface area contact between the pick tool and the pick tool holder, and also providing a sufficient volume of main body 102 for wearing through during use.

FIG. 2 shows a cross section view of an exemplary pick tool 200. The pick tool 200 comprises a strike tip 201 that has a working surface formed at least in part from a superhard material. The strike tip 201 is non-rotationally attached to a strike tip holder 202. In this example, the strike tip holder 202 is formed from cemented tungsten carbide. The strike tip holder 202 has a projection 203 that extends from an end opposite to the strike tip 201. Note that the projection 203 is not a necessary feature of the strike tip holder 201, as it could be brazed to a surface of the pick tool body 201 without needing a projection 203.

A steel pick tool body 204 is provided that has a bore into which the strike tip holder projection 203 is shrink fit or press fit, or press fit with a spacer or brazed, to ensure that the strike tip holder 203 is firmly and non-rotationally affixed to the pick tool body 204. The strike tip holder 202 is located at a first end of the pick tool body 204, and the pick tool body flares out to a shoulder at an opposite end of the pick tool body 204. A lower surface of the shoulder is termed an abutment surface 205, as the abutment surface 205 is in contact with an upper surface of a pick tool holder, as explained below. Note that areas of the steel pick tool body 204 that are expected to undergo significant wear in use may be provided with a hard face coating. A hard face coating is formed from a harder material, for example one base on tungsten carbide.

A shaft 206 extends from the abutment surface 205. The shaft 206 is arranged to pass into or through a bore in a pick tool holder. The shaft 206 also comprises a mechanism 207 for attaching the pick tool 200 to the pick tool holder. In the example of FIG. 2, the mechanism comprises a threaded bolt configured to engage with a corresponding nut, but any suitable type of attachment mechanism may be used. Examples include, but are not limited to, a twist lock mechanism, an attachment pin, a threaded portion configured to engage with a corresponding threaded attachment bolt, an interference fit with an angled ring and so on.

FIG. 2a shows the pick tool 200 in a first side elevation view, with the arrow showing the direction of travel when, in use, the pick tool 200 is mounted via a pick tool holder to a rotating drum. The pick tool body 204 has a length L and is not symmetrical about a main axis that passes through the length of the strike tip holder 202. When viewed from a perpendicular angle, as shown in FIG. 2b, to the view of FIG. 2A, the pick tool body 204 has a width W. The L:W aspect ratio is at least 1.5 to 1 and preferably no more than 3 to 1.

In exemplary embodiment, the aspect ratio allows the same surface area of the abutment surface 205 to contact the pick tool holder as a circular abutment surface, but with a much lower width W than a circle of the equivalent area. This reduces drag of the pick tool 100 as it degrades and passes through a formation, thereby making the degradation action more efficient, reducing the risk of sparks, and erosion of the pick tool body 200 while maintaining a surface area of the abutment surface sufficient to spread impact forces and minimize forces at the abutment surface 205 of the pick tool 200 and on the pick tool holder.

A further advantage is that a greater volume of steel in the pick tool body 204 is provided towards a leading edge (to the left of the strike tip 201 in FIG. 2a) of the pick tool body 204 than is provided at a trailing edge (to the right of the strike tip in FIG. 2a). This volume of steel becomes worn away after a period of use. A greater volume of steel increases the life of the pick tool body 204 before it must be replaced. It may be advantageous to apply a hard facing to the leading edge to further increase the life of the pick tool body 204.

In general, sharp corners at points of contact between the pick tool 200 and the formation are avoided in order to reduce stresses during use. For example, edges and corners may be provided with a radius or a chamfer to reduce the risk of stress-related cracks arising.

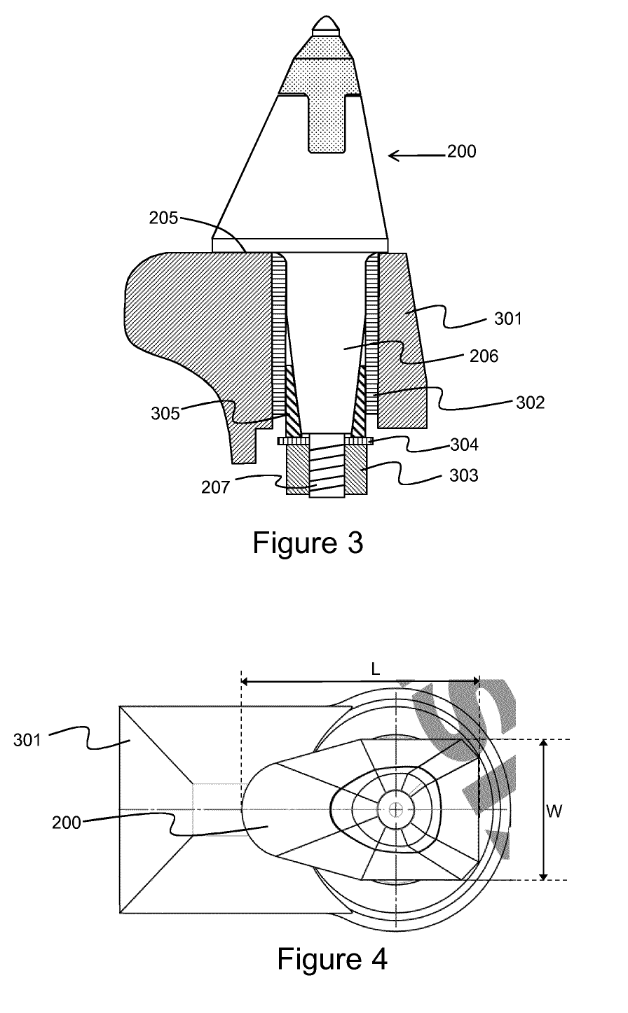

FIG. 3 shows the pick tool 200 mounted to a pick tool holder 301. The pick tool holder 301 has a bore through which the shaft 206 passes. The abutment surface 205 of the pick tool 200 abuts a surface of the pick tool holder 301. A spacer 302 is optionally included in the bore to improve the fitting of the shaft 206 within the pick tool holder 301. In the example of FIG. 3, a nut 303 connects with the corresponding threaded attachment mechanism 207. A washer 304 is located between the nut 303 and the shaft 206. An angled ring 305 is provided above the washer. The angled ring has an angled internal surface that corresponds with an angled surface of the shaft 206. When the nut 303 is tightened on the threaded attachment mechanism 206, it pushes the washer 304 upwards which, in turn, pushes the angled ring 305 toward the strike end of the pick body 200. As the angled ring 305 is pushes upwards it forms a strong interference fit between the shaft 206, the spacer 302 and the tool holder 301, and consequently forms a strong interference fit between the shaft 206 and the tool holder 301.

FIG. 4 is a top down plan view of the pick tool 200 attached to the pick tool holder 301, and shows the length L of the pick tool 200 and the width W of the pick tool 200. The narrow width W compared to the length L gives the leading edge of the pick tool 200 a ‘prow’ that assists in splitting a formation that has been degraded by the strike tip 201. It also assists in directing flow of spoil away from the pick tool 200.

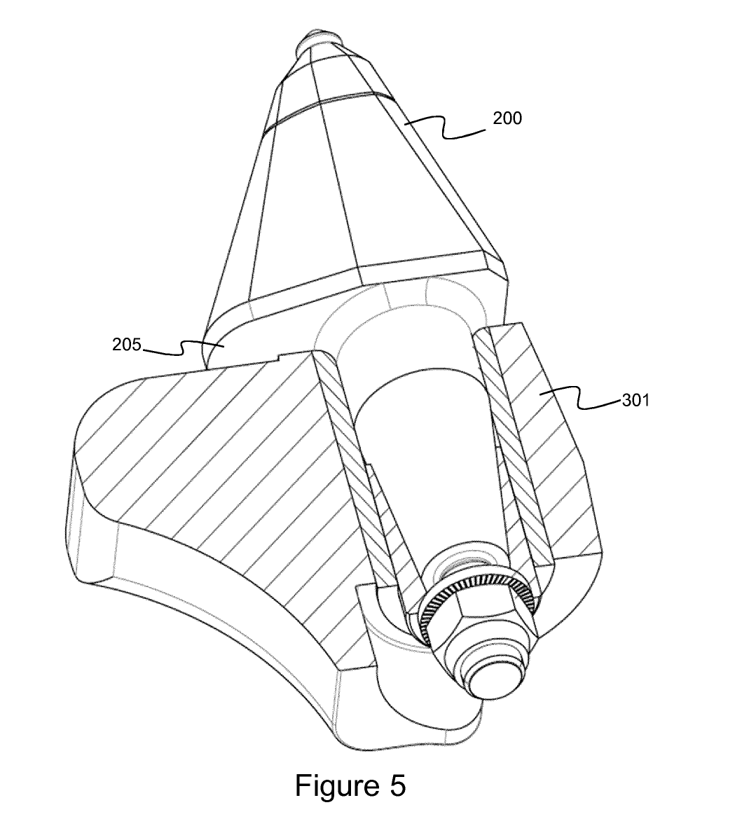

To further illustrate the concept, FIG. 5 is a perspective view of the pick tool 200 attached to the pick tool holder 301, with the pick tool holder 301 shown in cutaway view to illustrate how the pick tool 200 attaches to the pick tool holder 301.

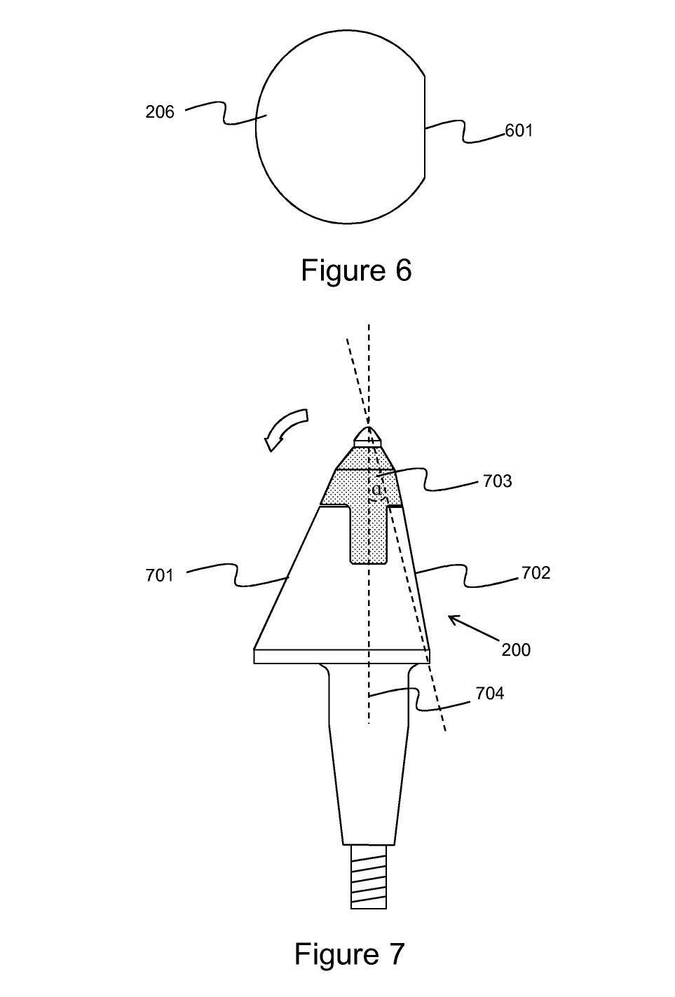

In order to ensure that the pick tool 200 does not rotate relative to the pick tool holder 301, inter-engaging surface formations may be provided on the pick tool 200 and the pick tool holder 301. FIG. 6 shows an example where the shaft 206 of the pick tool body 204 has a flattened portion 601 that engages with a similar flattened portion in the bore of the pick tool holder 301 (or the spacer 302 in the pick tool holder). Alternatively, inter-engaging surface formations may be provided on the pick tool body 204 and a corresponding surface of the pick tool holder 301. It will be appreciated that many different shapes of inter-engaging surface formation may be used, and the flattened portion 601 shown in FIG. 6 is only one example of a suitable surface formation. For example, the flattened portion is effective when the shaft 206 is substantially cylindrical, but an alternative form of inter-engaging surface formation is to have a shaft 206 that is not cylindrical. An elliptic or hexagonal cross-section area would provide inter-engaging surfaces that prevent rotation.

FIG. 7 shows the pick tool 200 of FIG. 2 with a leading edge 701 and a trailing edge 702. In use, when the pick tool 200 is attached to a rotating drum, the pick tool 200 travels substantially in the direction shown by the arrow. The pick tool is arranged so that, in use, the strike tip 201 first contacts a formation being degraded. However, the pick tool body 204 has a leading edge 701 that first approaches the formation as the drum rotates, and an opposite trialing edge 702. As the formation being degraded is unlikely to be smooth, the leading edge 701 will have some contact with the formation. Furthermore, the trailing edge 702 may be dragged along the surface of the formation as the strike tip 201 passes through the formation. The trialing edge 702 can be subject to a great deal of friction, which can give rise to a high temperature, high abrasion of the trailing edge, and an increased risk of sparking. This is mainly a problem as the pick wears and the trailing edge becomes more likely to contact the formation. An angle a 703 between a main axis 704 passing through the shaft 206 at the strike tip 201, and the shoulder of the pick body 200 at the abutment surface 205 at the trailing edge 702, is provided to be sufficiently low to reduce the incidence contact between the trailing edge 702 and the formation. An angle of less than 18° has been found to be suitable.

In some circumstances the risk and extent of inefficient contact between the leading edge 701 and uncut fresh rock surface may be similar to those for the trailing edge 702. The leading edge 701 utilizes the fact that rock fracturing will occur in front of it against abrasive contact with the fresh rock surface. However, when deep cuts and long failure cracks are considered to take place in field operations, the leading edge 701 may impact on, or contact with, rock area in front of the pick as extensively as the trailing edge 702, at least immediately before that area of rock completely turns into a rock chip/fragments. A similar low angle (e.g. less than 18°) between the abutment surface 205 and leading edge 701 can also be provided.

Note that in the example of FIG. 7, the pick tool body 204 is not symmetrical about the main axis 704, and the leading edge has an angle with respect to the main axis 704 that is higher than angle a 703. This arrangement allows an aspect ratio of L:W of between 1.5 and 3 to be used, while maintaining a low angle a 703 to reduce friction between the trailing edge 702 and the main axis 703. However, symmetrical shapes for the abutment surface may be used provided the L:W ratio is between 1.5:1 and 3:1.

Where the strike tip holder 202 has a projection 203 that extends into the pick tool body 204, the width W of the pick tool body must be at least as large as the maximum width of the projection 203, and preferably 1.5 times as large as the maximum width of the projection 203. This is because the sides of the pick tool body may be abraded during use to such an extent that the pick tool body cannot support the projection 203, and the strike tip holder 202 may no longer be attached to the pick tool body 204.

Certain terms and concepts as used herein are briefly explained below.

Synthetic and natural diamond, PCD, cubic boron nitride (cBN) and PCBN material are current examples of super-hard materials. As used herein, super-hard material has Vickers hardness of at least about 25 GPa. As used herein, synthetic diamond, which is also called man-made diamond, is diamond material that has been manufactured. As used herein, PCD material comprises an aggregation of a plurality of diamond grains, a substantial portion of which are directly inter-bonded with each other and in which the content of diamond is at least about 80 volume per cent of the material. Interstices between the diamond grains may be at least partly filled with a filler material that may comprise catalyst material for synthetic diamond, may be substantially empty, or may include a material introduced to the PCD after removal of a catalyst. As used herein, a catalyst material (which may also be referred to as a solvent/catalyst material) for synthetic diamond is capable of promoting the growth of synthetic diamond grains and or the direct inter-growth of synthetic or natural diamond grains at a temperature and pressure at which synthetic or natural diamond is thermodynamically stable. Examples of catalyst materials for diamond are Fe, Ni, Co and Mn, and certain alloys including these. Bodies comprising PCD material may comprise at least a region from which catalyst material has been removed from the interstices, leaving interstitial voids between the diamond grains. Note that the voids may be subsequently infiltrated with another material such as tungsten carbide, silicon carbide, silicon nitride, titanium carbide, titanium nitride, CBN or diamond.

As used herein, a PCD grade is a variant of PCD material characterized in terms of the volume content and or size of diamond grains, the volume content of interstitial regions between the diamond grains and composition of material that may be present within the interstitial regions. Different PCD grades may have different microstructures and different mechanical properties, such as elastic (or Young's) modulus E, modulus of elasticity, transverse rupture strength (TRS), toughness (such as so-called K1C toughness), hardness, density and coefficient of thermal expansion (CTE). Different PCD grades may also perform differently in use. For example, the wear rate and fracture resistance of different PCD grades may be different.

As used herein, PCBN material comprises grains of cubic boron nitride (cBN) dispersed within a matrix comprising metal and/or ceramic material.

Other examples of super-hard materials include certain composite materials comprising diamond or cBN grains held together by a matrix comprising ceramic material, such as silicon carbide (SiC), or cemented carbide material, such as Co-bonded WC material. For example, certain SiC-bonded diamond materials may comprise at least about 30 volume per cent diamond grains dispersed in a SiC matrix (which may contain a minor amount of Si in a form other than SiC). A further example is thermally stable polycrystalline diamond composite (TSP), which uses silicon carbide (SiC) binders. Such composites are stable up to 1200° C., but have reduced fracture toughness owing to the brittleness of the SiC and diamond.

As used herein, a shrink fit is a kind of interference fit between components achieved by a relative size change in at least one of the components (the shape may also change somewhat). This is usually achieved by heating or cooling one component before assembly and allowing it to return to the ambient temperature after assembly. Shrink-fitting is understood to be contrasted with press-fitting, in which a component is forced into a bore or recess within another component, which may involve generating substantial frictional stress between the components.

While this invention has been particularly shown and described with reference to embodiments, it will be understood by those skilled in the art that various changes in form and detail may be made without departing from the scope of the invention as defined by the appended claims. For example, although the abutment surface is shown as asymmetrical about the main axis, a symmetrical shape may be used. Furthermore, different shapes may be used to ensure no rotation between the shaft 206 and the pick tool holder 301. Various attachment mechanisms may be used to attach the pick tool 200 to the pick tool holder 301, examples of which are given above, but a skilled person will realize that other attachment mechanisms may be used.

1. A pick tool comprising a strike tip and a pick tool body, the pick tool body comprising:
a non-rotating strike tip at a first end of the pick tool body;
a shaft at a second end of the pick tool body, the shaft being configured to pass through an opening in a surface of a pick tool holder, the shaft being configured in use to be non-rotationally attached to the pick tool holder;
wherein the shaft projects from a pick tool abutment surface such that, when the pick tool is attached to the pick tool holder, the abutment surface abuts the pick tool holder surface; and
wherein the abutment surface has an aspect ratio between its length and width of between 1.5:1 and 3:1, and wherein the pick tool body comprises a leading edge and a trailing edge, the leading edge being, in use, the edge that first contacts a formation, the trailing edge having an angle of less than 18° between a main axis of the pick tool and an axis from the strike tip to the abutment surface at the trailing edge.

2. The pick tool according to claim 1, wherein the strike tip comprises a working surface, the working surface comprising a superhard material having a Vickers hardness of at least 25 GPa.

3. The pick tool according to claim 2, wherein the superhard material comprises any of polycrystalline diamond, PCD, polycrystalline cubic boron nitride, PCBN, a composite of tungsten carbide and any of diamond and cubic boron nitride, leached PCD, inter-grown cubic boron nitride and thermally stable polycrystalline diamond composite, TSP.

4. The pick tool according to claim 1, wherein the pick tool body further comprises a surface formation arranged to interlock with a corresponding surface formation on the pick tool holder to prevent relative rotation between the pick tool holder and the pick tool.

5. The pick tool according to claim 4, wherein the surface formation comprises a flat surface on or close to a portion of the shaft.

6. The pick tool according to claim 1, wherein the strike tip is attached to a cemented carbide holder, the cemented carbide holder comprising a projection, wherein the projection is non-rotationally fitted into an opening at the first end of the pick tool body.

7. The pick tool according to claim 1, for any of mining, road milling, or drilling into the earth.

8. A pick tool body, comprising:
an attachment point at a first end of the pick tool body configured to affix to a non-rotating strike tip;
a shaft at a second end of the pick tool body, the shaft being configured to pass through an opening in a surface of a pick tool holder;
wherein the shaft projects from a pick tool abutment surface such that, when the pick tool is attached to the pick tool holder, the abutment surface abuts the pick tool holder surface; and
wherein the abutment surface has an aspect ratio between its longest dimension and its second longest dimension of between 1.5:1 and 3:1, and wherein the pick tool body comprises a leading edge and a trailing edge, the leading edge being, in use, the edge that first contacts a formation, the trailing edge having an angle of less than 18° between a main axis of the pick tool and an axis from the strike tip to the abutment surface at the trailing edge.

9. The pick tool body according to claim 8, wherein the pick tool body further comprises a surface formation arranged to interlock with a corresponding surface formation on the pick tool holder to prevent relative rotation between the pick tool holder and the pick tool body.

10. The pick tool body according to claim 9, wherein the surface formation comprises a flat surface on or close to a portion of the shaft.

11. The pick tool body according to claim 8, further comprising an opening arranged to receive a projection from a cemented carbide strike tip holder for securing the strike tip holder to the pick tool body.

12. The pick tool body according to claim 8, for any of mining, road milling, or drilling into the earth.
